(19) United States
(12) Patent Application Publication
(10) Pub. No.: US 2015/0009020 A1
(43) Pub. Date: Jan. 8, 2015

(54) USER TERMINAL APPARATUS, DISPLAY DEVICE AND CONTROL METHOD THEREOF

(71) Applicant: Samsung Electronics Co., Ltd., Suwon-si (KR)

(72) Inventors: Joshi SHEKHAR, Suwon-si (KR); Seung-seop SHIM, Anyang-si (KR)

(21) Appl. No.: 14/323,117

(22) Filed: Jul. 3, 2014

(30) Foreign Application Priority Data
Jul. 4, 2013 (KR) 10-2013-0078306

(51) Int. Cl. G08C 17/02

(52) U.S. Cl. CPC G08C 17/02
USPC 340/12.5

(57) ABSTRACT

The control method of a user terminal apparatus includes receiving control information from a remote controller which is capable of performing a near field communication (NFC) to remotely control a plurality of electronic devices by using the NFC; determining whether the remote controller is a remote controller meeting predetermined conditions; connecting the remote controller to at least one of the electronic devices and a display device based on the received control information if it is determined that the remote controller is the remote controller meeting the predetermined conditions; receiving a control command from a user for the at least one of the electronic devices and the display device; and transmitting the received control command to the at least one of the electronic devices and the display device

### CROSS-REFERENCE TO RELATED APPLICATIONS

This application claims priority benefit from Korean Patent Application No. 10-2013-0078306, filed on Jul. 4, 2013 in the Korean Intellectual Property Office, the disclosure of which is incorporated herein by reference.

### BACKGROUND

1. Field

Apparatuses and methods consistent with the exemplary embodiments relate to a user terminal apparatus, a display device and a control method thereof, and more particularly, to a user terminal apparatus, a display device and a control method thereof which receives control information from a remote controller by using a near field communication (NFC) function and controls the display device and an electronic device to thereby remotely control the electronic device connected to the display device that has no NFC function.

2. Description of the Related Art

Near field communication (NFC) refers to a contactless, wireless near field communication module using a frequency band of 13.56 Mz as one of radio frequency identification (RFID) standards and is used to transmit data between terminal apparatuses in a close proximity of 10 cm.

The NFC is a noticeable next generation communication technology which has a short communication range and guarantees relatively good security at low costs. Since the NFC supports both data reading and writing functions, it does not require a dongle (reader) which is necessary for using the existing RFID. The NFC is similar to existing near field communication technologies such as Bluetooth, but does not need inter-device setting unlike Bluetooth.

Users are using various electronic devices, and desire to control and use the devices easily and conveniently. For example, a user may control an electronic device connected to a display device, by using a remote controller through wireless near field communication. However, the remote controller causes such inconvenience that a user should see the screen of the display device to control it. In particular, if the remote controller and the display device are located in different places which are blocked by a wall, a user may not control an electronic device connected to the display device.

In such a case, if the remote controller and the user terminal apparatus have an NFC function, a user may obtain connection information of the display device and the electronic device from the remote controller and control the display device and the electronic device through the user terminal apparatus. Then, a user may easily control the devices in any event and may feel less inconvenient.

### SUMMARY

Additional aspects and/or advantages will be set forth in part in the description which follows and, in part, will be apparent from the description, or may be learned by practice of the invention.

Accordingly, one or more exemplary embodiments provide a user terminal apparatus, a display device and a control method thereof which receives control information from a remote controller by using an NFC function and smoothly connects the display device and an electronic device to remotely control the electronic device connected to the display device that has no NFC function, and allows a user to easily and conveniently control the display device and the electronic device by using the control information.

According to an aspect of an exemplary embodiment, a control method of a user terminal apparatus may include: receiving control information from a remote controller which is capable of performing a near field communication (NFC) to remotely control a plurality of electronic devices by using the NFC; determining whether the remote controller is a remote controller meeting predetermined conditions; connecting the remote controller to at least one of the electronic devices and a display device based on the received control information if it is determined that the remote controller is the remote controller meeting the predetermined conditions; receiving a control command from a user for the at least one of the electronic devices and the display device; and transmitting the received control command to the at least one of the electronic devices and the display device.

The control information may include at least one of identification (ID) information, a control key and a control application of the plurality of electronic devices and the display device.

The connecting to at least one device may include identifying the electronic device that is capable of being wirelessly connected to the user terminal apparatus and the display device.

The control command may include at least one of a transmission mode to be used for the at least one device and a performance command to be issued for the at least one device.

The receiving the control command may include executing the control application; and setting a transmission mode for the control command.

The executing the control application may include displaying a user interface (UI) of the control application to remotely control the at least one device.

The transmitting the control command may include transmitting a direct control command to directly control the electronic device; and transmitting an indirect control command to cause the display device to control the electronic device.

According to an aspect of an exemplary embodiment, a control method of a display device may include: receiving information of an electronic device connected to a display device from at least one of a plurality of electronic devices and an external server; transmitting control information comprising the received information of the electronic device to a remote controller that is capable of performing an NFC; connecting to a user terminal apparatus; receiving a control command from the user terminal apparatus; and transmitting a control signal to remotely control the electronic device based on the received control command.

The control information may include at least one of ID information, a control key and a control application of the plurality of electronic devices and the display device.

The control command may include at least one of a command for controlling the display device and a command for remotely controlling the electronic devices.

According to an aspect of an exemplary embodiment, a user terminal apparatus may include: a receiver which receives data by using an NFC; a communicator which transmits and receives data; a user input interface which receives a user's input; and a controller which receives control information to remotely control a plurality of electronic devices by using the NFC from a remote controller that is capable of performing the NFC, determines whether the remote controller is a remote controller that meets predetermined conditions, and if the remote controller meets the predetermined conditions, connects the user terminal apparatus to at least one of the electronic devices and the display device based on the received control information, and controls the communicator to receive a control command for the at least one device from a user and to transmit the received control command to the at least one device.

The control information may include at least one of ID information, a control key and a control application of the plurality of electronic devices and the display device.

The controller may identify the electronic device that is capable of being wirelessly connected to the user terminal apparatus and the display device.

The control command may include at least one of a transmission mode to be used for the at least one device and a performance command to be issued for the at least one device.

The controller may set a transmission mode for the control command.

The user terminal apparatus further may include a UI generator to display the control application, wherein the controller may display a UI of the control application to remotely control the at least one device.

The controller may transmit a direct control command to directly control the electronic device, and transmits an indirect control command to cause the display device to control the electronic device.

According to an aspect of an exemplary embodiment, a display device may include: an interface which receives information of an electronic device connected to the display device out of a plurality of electronic devices; a communicator which transmits and receives data; and a controller which transmits control information comprising the received information of the electronic device to a remote controller that is capable of performing NFC, connects the remote controller to a user terminal apparatus, receives a control command from the user terminal apparatus, and controls the communicator to transmit a control signal to remotely control the electronic device based on the received control command.

The control information may include at least one of ID information, a control key and a control application of the plurality of electronic devices and the display device.

The control command may include at least one of a command for controlling the display device and a command for controlling the electronic device.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a user terminal apparatus according to an embodiment;

FIG. 2 is a block diagram of a user terminal apparatus according to another embodiment;

FIG. 3 illustrates an example of operations of the user terminal apparatus according to the embodiment;

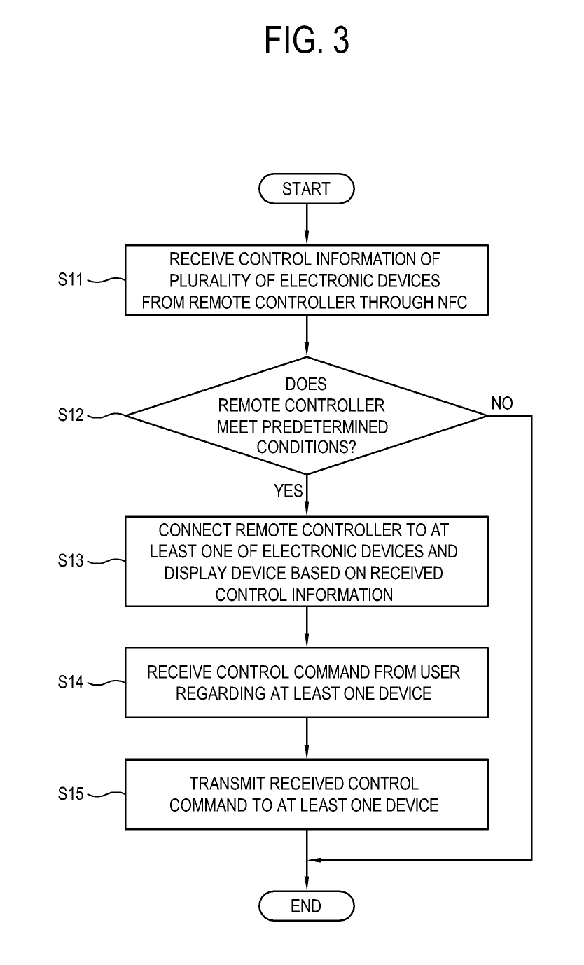

FIG. 4 illustrates an example of operations of the user terminal apparatus according to the another embodiment;

FIG. 5 is a block diagram of a display device according to the embodiment;

FIG. 6 is a block diagram of a display device according to the another embodiment;

FIG. 7 is a control flowchart showing operations of the display device according to the embodiment;

FIG. 8 is a control flowchart showing operations of the display device according to the another embodiment;

FIG. 9 illustrates an example of remotely controlling the display device and an electronic device by using the user terminal apparatus according to the another embodiment;

FIG. 10 illustrates an example of a control screen of the user terminal apparatus according to the another embodiment; and

FIG. 11 illustrates an example of transmitting and receiving information of the electronic device by the display device according to the another embodiment

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

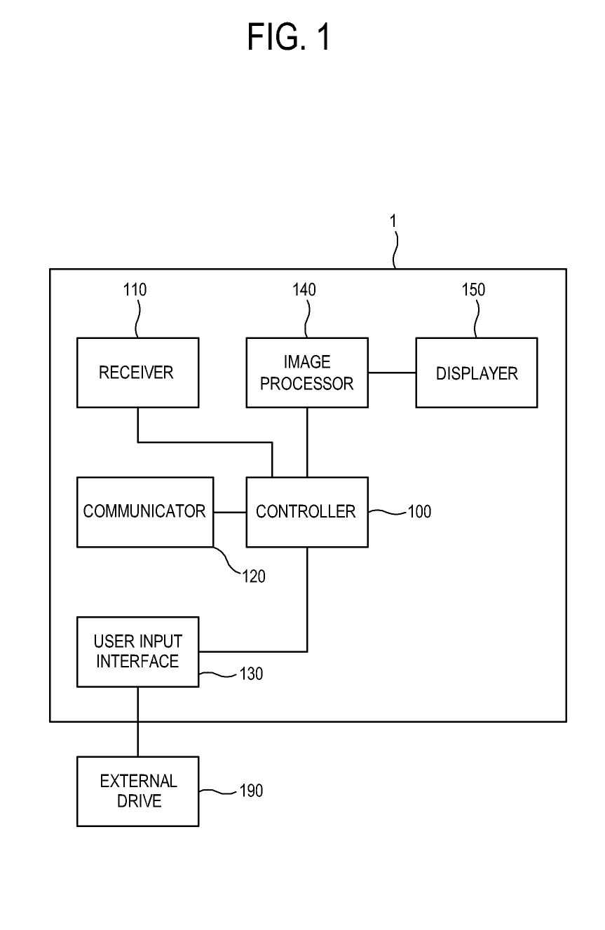

FIG. 1 is a block diagram of a user terminal apparatus 1 according to an embodiment. As shown therein, the user terminal apparatus 1 according to the embodiment may include a receiver 110, a communicator 120, a user input interface 130, an image processor 140, a displayer 150, and a controller 100. The user terminal apparatus 1 according to the embodiment may be implemented as a smart phone or a portable terminal apparatus.

The receiver 110 exchanges data with an external input source 190. The external input source may include a graphic card to convert generated data into an image signal and transmit the image signal to a display device 2, and may store therein a predetermined graphic card patch to perform color calibration. The external input source may be implemented as a remote controller 3 that is capable of performing a near field communication (NFC) function, but not limited thereto. The receiver 110 may exchange data with the external input source through digital visual interface (DVI), Component, high-definition multimedia interface (HDMI) and serial digital interface (SDI). The receiver 110 which is capable of performing the NFC may be provided as a contactless or contact-type wireless near field communication module. The receiver 110 may transmit data received by it, through a contactless or contact-type wireless near field communication module to the controller 100.

The receiver 110 may be connected to various external input cables to receive signals from the concerned external input in a wired manner, or receive signals wirelessly according to predetermined wireless communication standards.

The receiver 110 may transmit machine (MAC) address information of the user terminal apparatus 1 to the remote controller 3 for the user terminal apparatus 1 to perform wireless communication. Then, the communicator 120 may receive a wireless connection request from the electronic device 4 or the display device 2.

The communicator 120 may receive signals wirelessly according to predetermined wireless communication standards, or receive signals from a concerned external input in a wired manner by being connected to various external input cables.

The communicator 120 may include a plurality of connectors (not shown) to which respective cables are independently connected. The communicator 120 may receive signals from the connected external input, e.g., receive broadcasting signals, image signals or data signals according to HDMI, universal serial bus (USB) or Component or receive communication data through a communication network.

In addition to elements or parts for receiving signals/data from the external input, the communicator 120 may further include various additional elements or parts such as a wireless communication module (not shown) for wireless communication or a tuner (not shown) for tuning broadcasting signals, depending on a design type of the user terminal apparatus 1. The communicator 120 may transmit information/data/signals of the user terminal apparatus 1 to an external device as well as receiving signals from the external device. That is, the communicator 120 is not limited to the configuration for receiving signals from the external device and may be implemented as an interface for interactive communication. The communicator 120 may receive a control signal from a plurality of control devices for selecting a user interface (UI). The communicator 120 may include a communication module for known wireless near field communication such as Bluetooth, infrared (IR), ultra wideband (UWB) or Zigbee, and include a known communication port for wired communication. The communicator 120 may be used for various purposes including transmitting/receiving commands for manipulating a display, and transmitting/receiving data as well as receiving control signals for selecting UIs. The communicator 120 may receive a wireless connection request from the electronic device 4 or the display device 2.

The user input interface 130 may transmit predetermined various control commands or information to the controller 100 according to a user's manipulation and input. The user input interface 130 is implemented as a menu key or an input panel that is installed in an external part of the display device 2, or as a remote controller that is separated and spaced from the user terminal apparatus 1. Otherwise, the user input interface 130 may be integrally formed in the displayer 150. If the displayer 150 is a touch screen, a user may touch an input menu (not shown) displayed on the displayer 150 to transmit a predetermined command to the controller 100. The user input interface 130 may receive a user's motion. The user's motion may include a touch input. The user input interface 130 may directly receive a user's motion, or receive information of a user's motion from an external device 190.

The image processing operation of the image processor 140 may include, but not limited to, a decoding operation corresponding to an image format of image data, a de-interlacing operation for converting interlace image data into progressive image data, a scaling operation for adjusting image data into a predetermined resolution, a noise reduction operation for improving a quality of an image, a detail enhancement operation, a frame refresh rate conversion, etc.

The image processor 140 may be implemented as a system-on-chip (SoC) which integrates the aforementioned functions or may be implemented as an image processing board (not shown) which is formed by installing independent elements performing the aforementioned processes in a printed circuit board (PCB), and may be installed in the display device 2.

The image processor 140 may process a broadcasting signal including an image signal transmitted through the communicator 120, and a source image including an image signal supplied by an image supply source (not shown). The image processor 140 may output the processed image signal to the display device 2, on which the processed source image may be displayed.

The displayer 150 may display an image thereon based on the image signal output by the image processor 140. The displayer 150 may be implemented as various displays including, without limitation, liquid crystal, plasma, light-emitting diode, organic light-emitting diode, surface-conduction electron-emitter, carbon nano-tube, and nano-crystal.

The displayer 150 may further include additional elements depending on its embodiment type. For example, the displayer 150 as a liquid crystal display, may include a liquid crystal display (LCD) panel (not shown), a backlight unit (not shown) emitting light to the LCD panel and a panel driving substrate (not shown) driving the LCD panel.

The controller 100 may control overall internal elements of the user terminal apparatus 1. The controller 100 may receive control information through the NFC from the remote controller 3 that is capable of performing the NFC to remotely control the plurality of electronic devices 4, and determine whether the remote controller 3 is the remote controller 3 that meets predetermined conditions. If it is determined that the remote controller 3 meets the predetermined conditions, the controller 100 connects the remote controller 3 to at least one of the electronic device 4 and the display device 2, and controls the communicator 120 to receive a control command from a user regarding the at least one device and transmit the received control command to the at least one device. For example, any electronic device, which is capable of performing the NFC and controlling the plurality of electronic device, may be used for the remote controller.

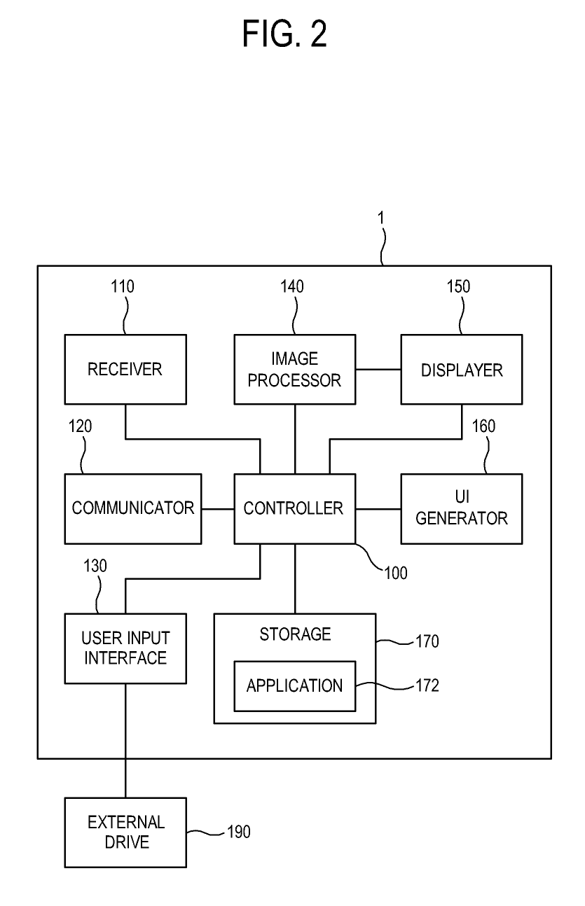

FIG. 2 is a block diagram of a user terminal apparatus 1 according to another embodiment. As shown therein, the user terminal apparatus 1 according to the another embodiment includes the elements shown in FIG. 1, and may further include a UI generator 160 and a storage 170.

The UI generator 160 may generate a UI for operating an executed application program. The generated UI may include a plurality of sub UIs provided in the form of icons or texts, and operate an application program corresponding to a particular sub UI if the sub UI is selected by a user through a portable terminal apparatus. That is, the respective sub UIs may be generated for a plurality of functions or events to operate an application program that is executed on the user terminal apparatus 1.

The UI generator 160 may include software and/or hardware function for generating and controlling a UI displayed on the displayer 150, and may be controlled by the controller 100 (to be described later) to perform such software and/or hardware function. That is, the UI generator 160 may not be implemented as an additional chipset or an additional microprocessor.

The storage 170 may include a writable ROM in which data remain even upon cutoff of power to the user terminal apparatus 1, and to reflect any change in respect of a user. That is, the storage 170 may be implemented as one of a flash memory, an erasable programmable read only memory (EPROM) and an electrically erasable programmable read only memory (EEPROM). The storage 170 may store data transmitted by the remote controller 3 and an external device 190 and provide the controller 100 with various control signals stored in the storage 170. The storage 170 may store therein data transmitted through the communicator 120, i.e., data including at least one of identification (ID) information, a control key and a control application 172 of the display device 2 and the electronic device 4 from the remote controller 3 and the external device 190.

The controller 100 may control the storage 170 to store therein control information received by the receiver 110 and including at least one of the ID information, the control key and the control application 172 of the plurality of electronic devices 4 and/or the display device 2.

The controller 100 may control the communicator 120 to identify at least one of the plurality of the electronic device 4 that may be wirelessly connected to the user terminal apparatus 1 and the display device 2.

The controller 100 may control the communicator 120 to receive a user's control command from a user including at least one of a transmission mode to be used for at least one device and a performance command to be issued for at least one device, and transmit the user's control command to the at least one device.

The controller 100 may set a transmission mode for a control command. The transmission mode may include one of communication modes for a mobile phone which is called 2G or 3G such as wireless mobile communication modes including wireless near field communication, i.e., Bluetooth, Wireless-Fidelity (Wi-Fi), Infrared (IR), UWB, and Zigbee, and wireless remote area communication, i.e., Wireless Broadband Internet (Wibro) as wireless wideband area network (WWAN). The transmission mode is not limited to the foregoing as long as it is on a wireless connection basis, and may be changed depending on the transmission distance. If a user desires to control the electronic device 4 from the outside, he/she may transmit a control command to the display device 2 by using a remote area communication method such as the Internet.

The controller 100 may control the UI generator 160 to generate a UI of the control application 172 and display the UI on the displayer 150 to control the display device 2 and/or the electronic device 4.

The controller 100 may generate a direct control command for directly controlling the electronic device 4 and an indirect control command for causing the display device 2 to control the electronic device 4 and transmit the control commands to the electronic device 4 and the display device 2. For example, the display device 2 performs various operations, and may not control the electronic device 4 in certain cases. Then, the controller 100 may receive a response from the display device 2 regarding the incapability of performing the control operation. In such a case, the controller 100 may transmit the direct command to the electronic device 4 and control the electronic device 4.

The controller 100 may control the receiver 110 to transmit address information of the user terminal apparatus 1 to the remote controller 3 through the NFC. In doing so, interactive connections may be performed by the electronic device 4 and the display device 2. That is, the user terminal apparatus 1 may attempt to be connected to the electronic device 4, and the electronic device 4 may also be connected to the user terminal apparatus 1 by using the address information of the user terminal apparatus 1.

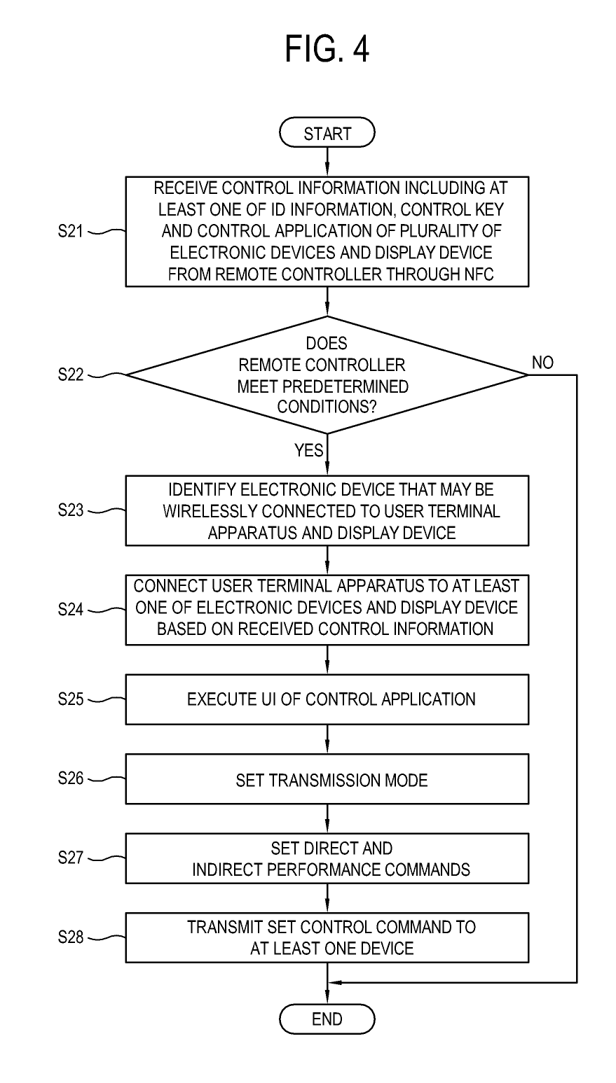

FIG. 4 illustrates an example of operations of the user terminal apparatus 1 according to the embodiment.

A user tags the user terminal apparatus 1 to the remote controller 3 that may perform the NFC. The controller 100 controls the receiver 110 to receive control information from the remote controller 3 that may perform the NFC, through the NFC to thereby remotely control the plurality of electronic devices 4 and the display device 2 (S21).

The controller 100 determines whether the tagged remote controller 3 is the remote controller 3 that meets preset conditions (S22).

The predetermined conditions may refer to those used to determine whether the remote controller 3 is set to perform the NFC. If the remote controller 3 does not meet the predetermined conditions, the controller 100 may not store in the storage 170 data including the received control information. If it is determined that the remote controller 3 is the remote controller 3 that meets the predetermined conditions, the controller 100 identifies the electronic device 4 that may be wirelessly connected to the user terminal apparatus 1 and the display device 2 (S23). Here, if remote control has storage then the remote control may store the information. Else the information may be stored in the display device. This information may be transferred to the remote control from the electronic device when the user terminal apparatus is brought in vicinity of the remote control for the NFC communication.

Based on the received control information, i.e., based on the ID information of the electronic devices 4 and the display device 2, the controller 100 attempts to connect the user terminal apparatus 1 to at least one of the electronic device 4 and the display device 2. The controller 100 connects the user terminal apparatus 1 to the at least one of the electronic device 4 and the display device 2 by using an available transmission mode such as Bluetooth or Wi-Fi. The electronic device 4 and the display device 2 may connect to the user terminal apparatus 1 through an available transmission mode.

A user executes the UI of the control application 172 (S25).

A user sets the transmission mode by using the executed control application 172 (S26). A user sets control commands, i.e., performance commands including a direct control command for directly controlling the electronic device 4 and an indirect control command for causing the display device 2 to control the electronic device 4 (S27).

The received control command is transmitted to the at least one device (S28).

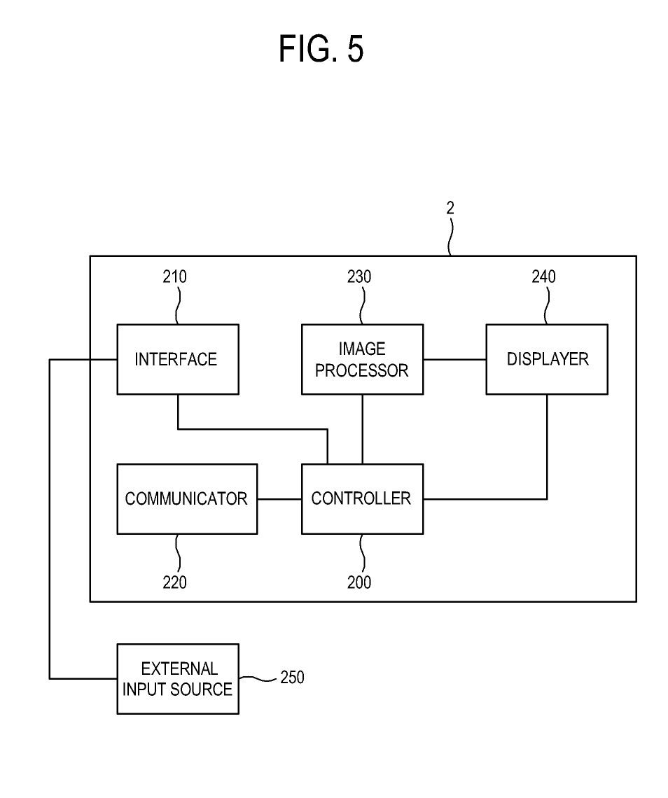

FIG. 5 is a block diagram of the display device 2 according to the embodiment. As shown therein, the display device 2 according to the embodiment may include an interface 210, a communicator 220, an image processor 230, a displayer 240 and a controller 200. The display device 2 according to the embodiment may be implemented as a smart TV, a smart phone, a laptop computer or a tablet PC.

The interface 210 exchanges data with an external input source 250. The external input source may include a graphic card to convert generated data into an image signal and transmit the image signal to the display device 2, and may store therein a predetermined graphic card patch to perform color calibration. The external input source 250 may be implemented as a PC and the electronic device 4, but not limited thereto. The receiver 210 may exchange data with the external input source through such as DVI, Component, HDMI and SDI.

The receiver 110 may be connected to various external input cables to receive signals from the concerned external input in a wired manner, or receive signals wirelessly according to predetermined wireless communication standards. By doing so, the interface 210 may receive information of the electronic device 4 connected to the display device 2 out of the plurality of electronic devices 4.

In addition to elements for receiving signals/data from the external input, the communicator 220 may further include various additional elements such as a wireless communication module (not shown) for wireless communication or a tuner (not shown) for tuning broadcasting signals, depending on a design type of the display device 2. The communicator 220 may transmit information/data/signals of the display device 2 to an external device 190 as well as receiving signals from the external device. That is, the communicator 220 is not limited to the configuration for receiving signals from the external device and may be implemented as an interface for interactive communication. The communicator 220 may receive a control signal from a plurality of control devices for selecting a UI. The communicator 220 may include a communication module for known wireless near field communication such as Bluetooth, IR, UWB or Zigbee, and include a known communication port for wired communication. The communicator 220 may be used for various purposes including transmitting/receiving commands for manipulating a display, and transmitting/receiving data as well as receiving control signals for selecting UIs.

The image processor 230 and the displayer 240 have the same roles as those in FIG. 1, and repetitive description will be omitted.

The controller 200 controls overall elements of the display device 2. The controller 200 may control the communicator 220 to transmit control information including the information of the electronic device 4 transmitted to the interface, to the remote controller 3 that may perform the NFC, to connect the display device 2 to the user terminal apparatus 2, to receive a control command from the user terminal apparatus 1, and to transmit a control signal based on the received control command to remotely control the electronic device 4.

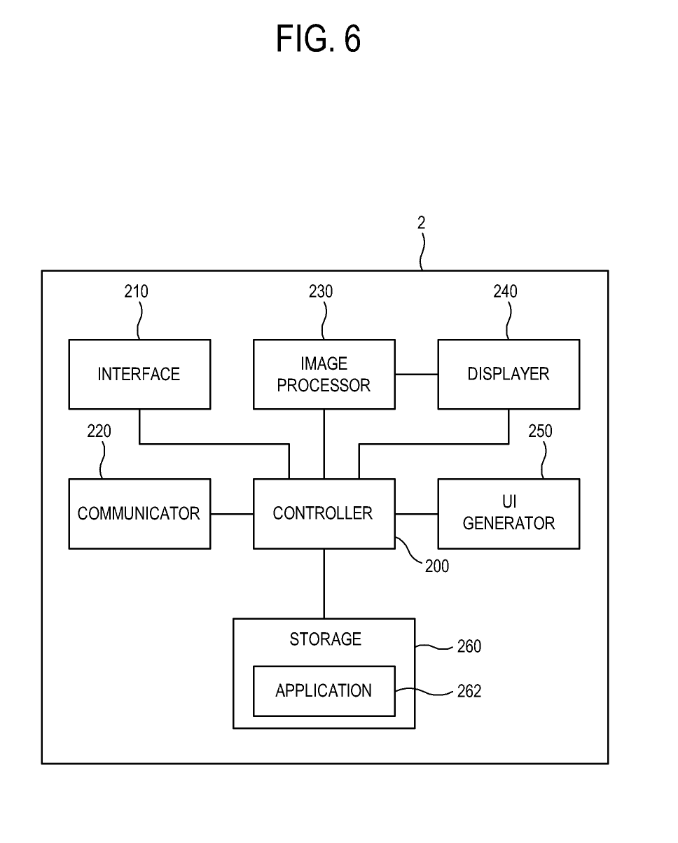

FIG. 6 is a block diagram of a display device 2 according to another embodiment. As shown therein, the display device 2 according to the another embodiment includes the elements shown in FIG. 5, and may further include a UI generator 250 and a storage 260.

The UI generator 250 and the storage 260 have the same roles as those in FIG. 2, and detailed description will be omitted.

The UI generator 250 may be displayed by the remote controller 3 and according to a user's input, and may generate and display a UI of an application 262 controlling the electronic device 4.

The storage 260 may store therein at least any one of ID information, a control key and the control application 262 of the electronic device 4 connected to the display device 2.

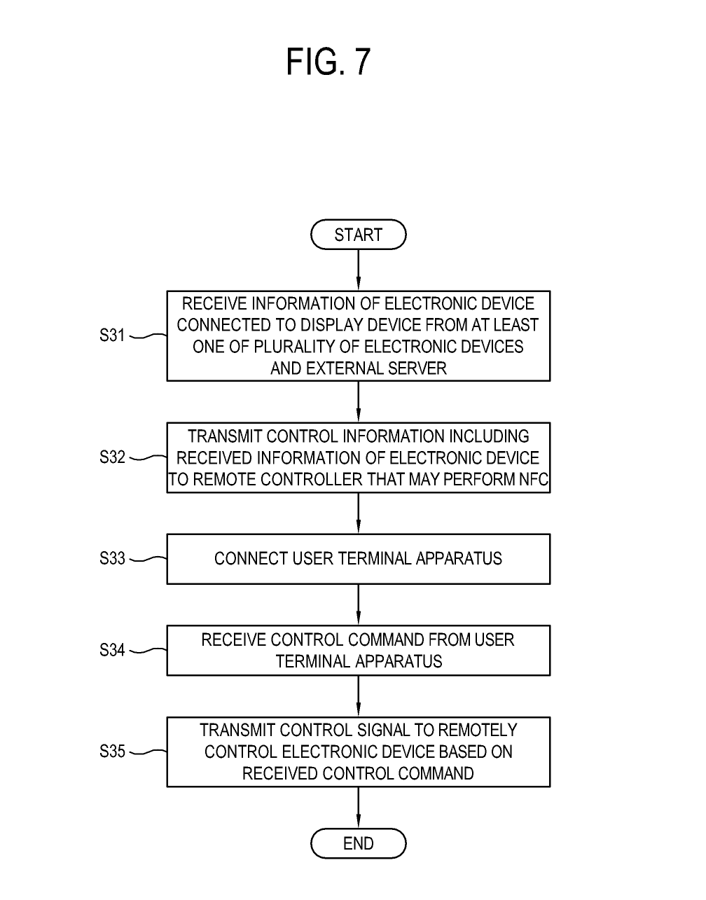

FIG. 7 is a control flowchart showing operations of the display device 2 according to the embodiment.

Information of the electronic device 4 connected to the display device 2 is transmitted by at least one of the plurality of electronic devices 4 and the external server (S31). The control information including the received information of the electronic device 4 is transmitted to the remote controller 3 that may perform the NFC (S32). The remote controller 3 includes the storage 260, which may store therein the control information transmitted by the display device 2. The display device 2 is connected to the user terminal apparatus 1 (S33). The user terminal apparatus 1 may receive the information including at least any one of the ID information, the control key and the control application 262 of the display device 2 from the remote controller 3, and may attempt to connect to the display device 2 through the available wireless communication mode. The display device 2 may also search an available device that may be wirelessly connected thereto and connect to the user terminal apparatus 1, but not limited thereto. After the display device 2 is connected to the user terminal apparatus 1, the display device 2 receives the control command from the user terminal apparatus 1 (S34). Based on the received control command, the control signal is transmitted to the electronic device 4 to remotely control the electronic device 4 (S35).

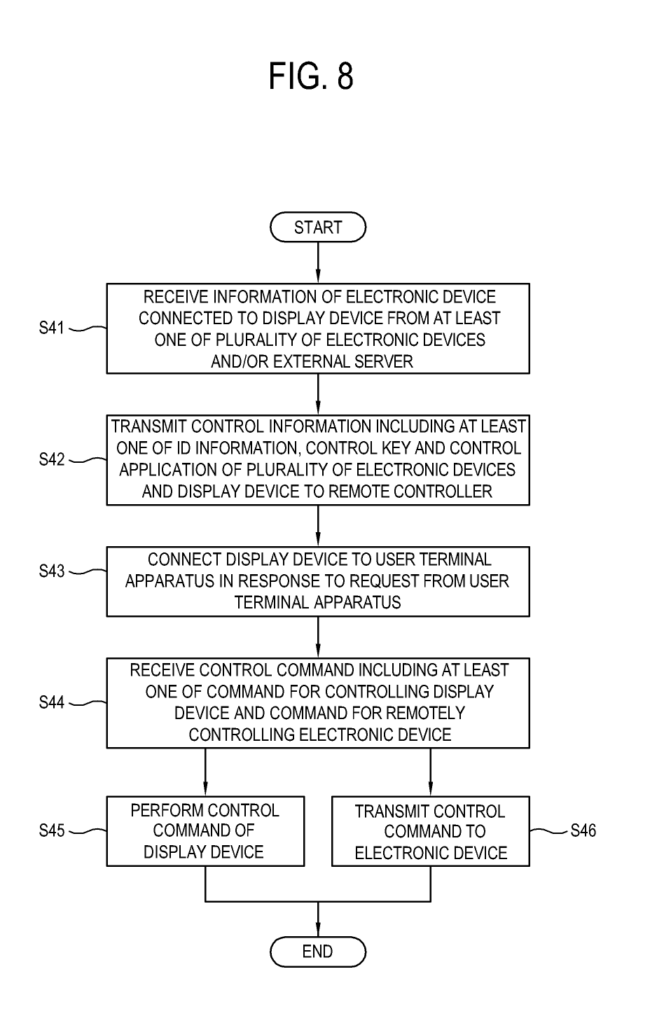

FIG. 8 is a control flowchart showing operations of the display device 2 according to the another embodiment.

Information of the electronic device 4 connected to the display device 2 is transmitted by at least one of the plurality of electronic devices 4 and the external server (not shown)(S41).

The control information including the received information of the electronic device 4, i.e., the control information including at least one of the ID information, the control key and the control application 262 of the plurality of electronic devices 4 and the display device 2 is transmitted to the remote controller 3 that may perform the NFC (S42). The remote controller 3 may include the storage 260, which may store therein the control information transmitted by the display device 2.

In response to the request from the user terminal apparatus 1, the display device 2 is connected to the user terminal apparatus 1 (S43). The user terminal apparatus 1 may receive the information including at least any one of the ID information, the control key and the control application 262 of the display device 2 from the remote controller 3 and attempt to be connected to the display device 2 by using the available wireless communication mode. The display device 2 may also search the available device that may be wirelessly connected thereto and may be connected to the user terminal apparatus 1, but not limited thereto.

After the display device 2 is connected to the user terminal apparatus 1, the display device 2 receives the control command including at least one of the command for controlling the display device 2 and the command for remotely controlling the electronic device 4 from the user terminal apparatus 1 (S44). Based on the received control command, the command for controlling the display device 2 is performed (S45). The command for controlling the display device 2 may include a control command for changing a channel, adjusting volume or turning on and off the display device 2, like the control command of the remote controller 3. However, it is not limited therein.

Based on the received control command, the control signal is transmitted to the electronic device 4 to remotely control the electronic device 4 (S46). The control signal for remotely controlling the electronic device 4 may include control commands for turning on an air conditioner connected to the display device 2 to adjust temperatures, and set wind strength, wind direction and air-conditioning mode.

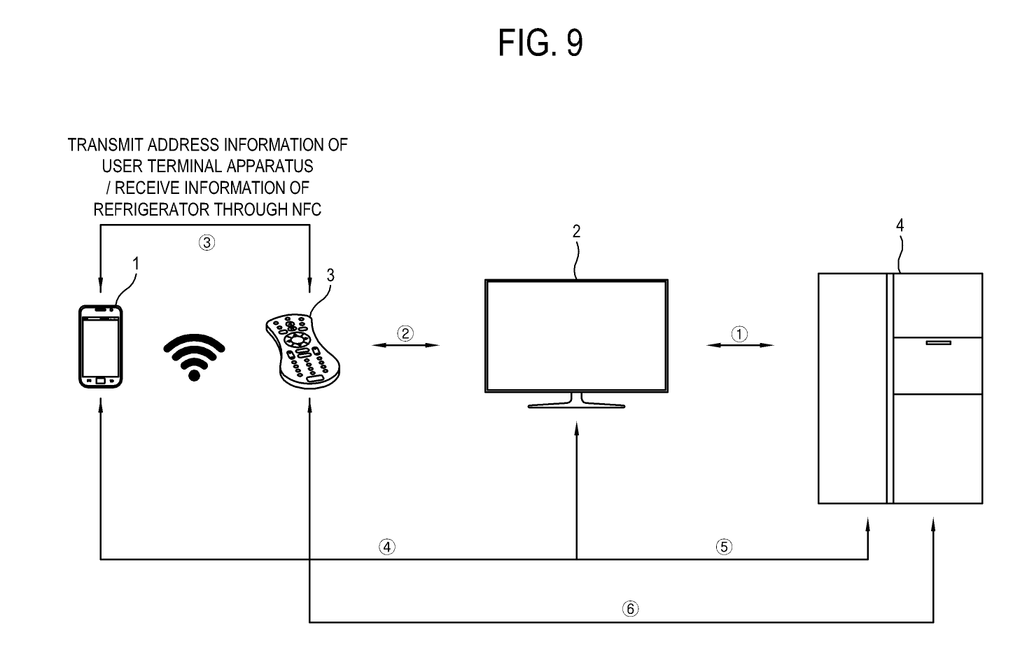

FIG. 9 illustrates an example of remotely controlling the display device 2 and the electronic device 4 by using the user terminal apparatus 1 according to the another embodiment.

The display device 2 receives the remote control information from the connected electronic device 4 and/or the external server (not shown) (\textcircled{1}) and transmits the information to the remote controller 3 (\textcircled{2}).

The user terminal apparatus 1 receives the control information of the display device 2 and the electronic device 4, for example, electronic device 4 is a refrigerator, from the remote controller 3 through the contact-type and/or contactless method by using the NFC (\textcircled{3}). The user terminal apparatus 1 may transmit the address information of the user terminal apparatus 1 to the remote controller 3 by using the NFC (\textcircled{3}).

The user terminal apparatus 1 is connected to the display device 2 and transmits the control command to remotely control the display device 2 and the electronic device 4 (\textcircled{4}).

It has been explained that the remote controller 3 only transmits the data, but not limited thereto. The remote controller 3 may also remotely control the display device 2 and the electronic device 4 by utilizing the application 262 for remotely controlling the display device 2 and the electronic device 4 (\textcircled{1}, \textcircled{2} and \textcircled{6}). However, it is understood that any electronic device, which is capable of performing the NFC, may be remotely control the display device 2.

If the control command transmitted by the user terminal apparatus 1 is the indirect control command for remotely controlling the electronic device 4, the control signal is transmitted to the electronic device 4 to remotely control the electronic device 4 (\textcircled{1} and \textcircled{5}).

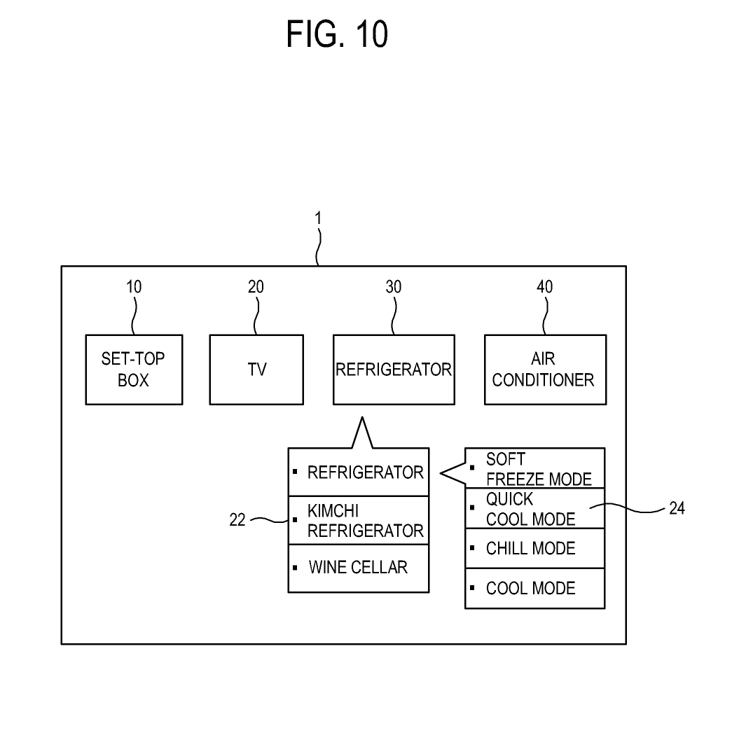

FIG. 10 illustrates an example of a control screen of the user terminal apparatus 1 according to the another embodiment.

If the user terminal apparatus 1 is tagged to the remote controller 3, the user terminal apparatus may receive the data including at least one of the ID information, the control key and the control application 262 of the display device 2 and the electronic device 4 stored in the remote controller 3, by using the NFC. Once the ID information and the control key is transmitted to the user terminal apparatus 1, the control application 262 which is stored in the user terminal apparatus 1 in advance may be matched with the ID information and the control key for utilization.

As shown in FIG. 10, main menus for controlling the electronic devices 40 such as a set-top box 10, a TV 20, a refrigerator 30 and an air conditioner 40 may be displayed on an upper part of a UI screen of the control application 262. If a user selects the refrigerator 30 from the main menus, a first sub menu 22 including the refrigerator 30, a kimchi refrigerator 30 and a wine cellar 30 may be displayed. If a user selects the refrigerator 30 from the first sub menus 22, a second sub menu 24 including soft freeze mode, quick cool mode, chill mode and cool mode are displayed. If a user changes from the cool mode, which is currently set to the quick cool mode, the control command with respect to the refrigerator 30 may be transmitted to the display device 2 or the refrigerator 30.

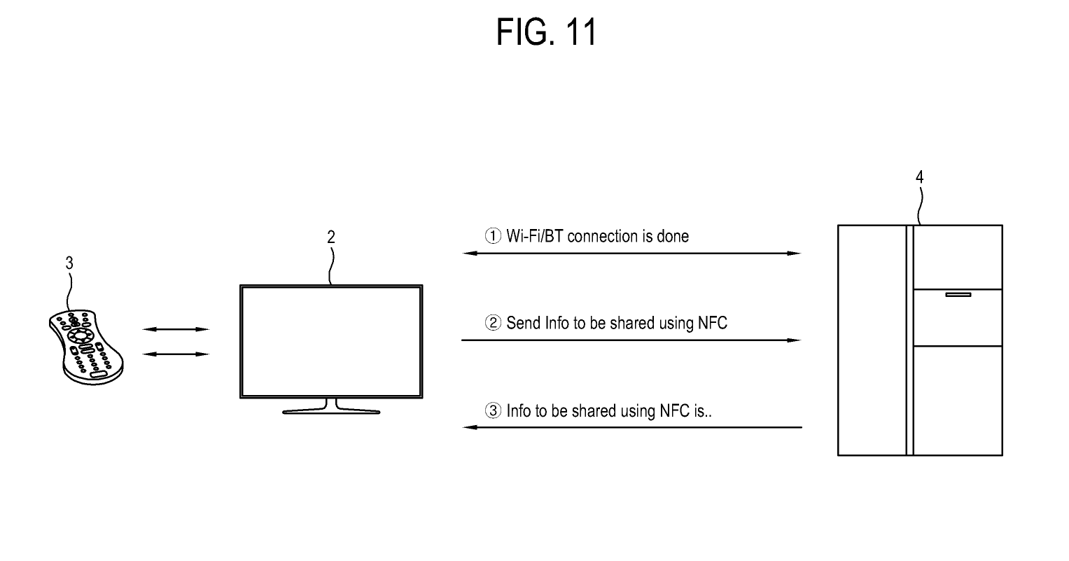

FIG. 11 illustrates an example of transmitting and receiving information of the electronic device 4 by the display device 2 according to the another embodiment.

The display device 2 is wirelessly connected to the refrigerator 4 (\textcircled{1}).

If the display device 2 is wirelessly connected to the refrigerator 4, the display device 2 requests the refrigerator 4 to transmit the address information and control information of the refrigerator 4 to be transferred using the NFC (\textcircled{2}).

Then, the refrigerator 4 transmits the address information and control information to the display device 2 to use the NFC (\textcircled{3}).

Through the foregoing process, the display device 2 receives and stores the address information and the control information of the electronic device 4 that is adjacent to the display device 2, and transmits the address information and the control information of the electronic device 4 to the remote controller 3. Then, the remote controller 3 receives and stores the address information and the control information of the electronic device 4, and if the user terminal apparatus 1 uses the NFC, may share the address information and the control information of the electronic device 4 and the display device 2 with the user terminal apparatus 1.

The display device according to the embodiment may be implemented as an electronic device and may receive the information of the electronic device that is adjacent to the display device and transmit the information to the remote controller. The remote controller may be replaced by the user terminal apparatus according to the embodiment and perform the same operation. Through the aforementioned user terminal apparatus 1 and display device 2, the control information is transmitted by the remote controller 3 through the NFC to remotely control the electronic device 4 connected to the display device 2 that has no NFC function to thereby smoothly connect the display device 2 and the electronic device 4, and to easily and conveniently control the display device 2 and the electronic device 4 by using the control information.

As described above, a user terminal apparatus, a display device and a control method thereof according to the embodiments receives control information from a remote controller by using NFC, and easily and conveniently controls the electronic device from a remote place which is connected to the display device that has no NFC function.

The apparatus and methods according to the above-described example embodiments may use one or more processors. For example, a processing device may be implemented using one or more general-purpose or special purpose computers, such as, for example, a processor, an image processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Some example embodiments of the present disclosure can also be embodied as a computer readable medium including computer readable code/instruction to control at least one component of the above-described example embodiments. The medium may be any medium that can storage and/or transmission the computer readable code.

Aspects of the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA). Some or all of the operations performed according to the above-described example embodiments may be performed over a wired or wireless network, or a combination thereof.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Also, while an illustration may show an example of the direction of flow of information for a process, the direction of flow of information may also be performed in the opposite direction for a same process or for a different process.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A control method of a user terminal apparatus, the control method comprising:
receiving control information from a remote controller which is capable of performing a near field communication (NFC) to remotely control a plurality of electronic devices by using the NFC;
determining whether the remote controller is a remote controller meeting predetermined conditions;
connecting the remote controller to at least one of the electronic devices and a display device based on the received control information if it is determined that the remote controller is the remote controller meeting the predetermined conditions;
receiving a control command from a user for the at least one of the electronic devices and the display device; and
transmitting the received control command to the at least one of the electronic devices and the display device.

2. The control method according to claim 1, wherein the control information comprises at least one of identification (ID) information, a control key and a control application of the plurality of electronic devices and the display device.

3. The control method according to claim 1, wherein the connecting to at least one device comprises identifying the electronic device that is capable of being wirelessly connected to the user terminal apparatus and the display device.

4. The control method according to claim 1, wherein the control command comprises at least one of a transmission mode to be used for the at least one device and a performance command to be issued for the at least one device.

5. The control method according to claim 1, wherein the receiving the control command comprises executing the control application; and
setting a transmission mode for the control command.

6. The control method according to claim 5, wherein the executing the control application comprises displaying a user interface (UI) of the control application to remotely control the at least one device.

7. The control method according to claim 1, wherein the transmitting the control command comprises transmitting a direct control command to directly control the electronic device; and
transmitting an indirect control command to cause the display device to control the electronic device.

8. A control method of a display device, the control method comprising:
receiving information of a first electronic device connected to a display device from at least one of a plurality of electronic devices;
transmitting control information comprising the received information of the first electronic device to a second electronic device that is capable of performing a near field communication (NFC);
connecting to a user terminal apparatus;
receiving a control command from the user terminal apparatus; and
transmitting a control signal to remotely control the first electronic device based on the received control command.

9. The control method according to claim 8, wherein the control information comprises at least one of ID information, a control key and a control application of the plurality of electronic devices and the display device.

10. The control method according to claim 8, wherein the control command comprises at least one of a command for controlling the display device and a command for remotely controlling the electronic devices.

11. The control method according to claim 8, wherein the second electronic device is a remote controller.

12. A user terminal apparatus comprising:
a receiver which receives data by using a near field communication (NFC);
a communicator which transmits and receives data;
a user input interface which receives a user's input; and
a controller which receives control information to remotely control a plurality of electronic devices by using the NFC from a remote controller that is capable of performing the NFC, determines whether the remote controller is a remote controller that meets predetermined conditions, and if the remote controller meets the predetermined conditions, connects the remote controller to at least one of the electronic devices and the display device based on the received control information, and controls the communicator to receive a control command for the at least one device from a user and to transmit the received control command to the at least one device.

13. The user terminal apparatus according to claim 12, wherein the control information comprises at least one of ID information, a control key and a control application of the plurality of electronic devices and the display device.

14. The user terminal apparatus according to claim 12, wherein the controller identifies the electronic device that is capable of being wirelessly connected to the user terminal apparatus and the display device.

15. The user terminal apparatus according to claim 12, wherein the control command comprises at least one of a transmission mode to be used for the at least one device and a performance command to be issued for the at least one device.

16. The user terminal apparatus according to claim 12, wherein the controller sets a transmission mode for the control command.

17. The user terminal apparatus according to claim 16, further comprising a UI generator to display the control application, wherein the controller displays a UI of the control application to remotely control the at least one device.

18. The user terminal apparatus according to claim 12, wherein the controller transmits a direct control command to directly control the electronic device, and transmits an indirect control command to cause the display device to control the electronic device.

19. A display device comprising:
an interface which receives information of an electronic device connected to the display device out of a plurality of electronic devices;
a communicator which transmits and receives data; and
a controller which transmits control information comprising the received information of the electronic device to a remote controller that is capable of performing a near field communication (NFC), connects the remote controller to a user terminal apparatus, receives a control command from the user terminal apparatus, and controls the communicator to transmit a control signal to remotely control the electronic device based on the received control command.

20. The display device according to claim 19, wherein the control information comprises at least one of identification (ID) information, a control key and a control application of the plurality of electronic devices and the display device.

21. The display device according to claim 19, wherein the control command comprises at least one of a command for controlling the display device and a command for controlling the electronic device.
